(19) United States
(12) Patent Application Publication
(10) Pub. No.: US 2010/0268769 A1
(43) Pub. Date: Oct. 21, 2010

(54) System and method for structuring information

(76) Inventor: H. Ted Goranson, Virginia Beach, VA (US)

Correspondence Address: Ted Goranson, 1976 Munden Point Rd., Virginia Beach, VA, 23457, US

(21) Appl. No.: 12/798,487

(22) Filed: Apr. 5, 2010

Related U.S. Application Data
(63) Continuation-in-part of application No. 12/105,143, filed on Apr. 17, 2008.
(60) Provisional application No. 61/166,579, filed on Apr. 3, 2009.

(51) Int. Cl. G06F 15/16; G06F 17/30

(52) U.S. Cl. 709/203; 707/769; 707/E17.014

(57) ABSTRACT

The present invention provides a novel computer system that synthesizes object programming, functional programming, data-flow programming, mathematical logic and cognitive modeling. The synthesis allows a system to exist which provides for close alignment among the manner in which a user interacts with a system, how that interaction is logically parsed, how set-theoretic composition of the logic results, how that set-theoretic algorithm builds functional reactive flows and how those flows are structured for display to a user.

### CROSS REFERENCES TO RELATED APPLICATIONS

This application claims the benefit of U.S. provisional patent application No. 61/166,579 filed Apr. 3, 2009. It also is a continuation-in-part of U.S. patent application Ser. No. 12/105,143 filed Apr. 17, 2008.

### FIELD OF THE INVENTION

The embodiments disclosed herein relate to a system architecture and a method to represent information, process information and display the structure of information.

### BACKGROUND OF THE INVENTION

Technologies exist to gather and characterize vast quantities of information. However, for certain uses, in order for the information to be valuable, it needs to be structured and displayed. In general, the more sophisticated and complex these structures, the more the value that can be obtained from the information. Computing systems have been used to structure and present this information, but the results are unintuitive, not dynamically responsive, and not individually tailorable to the conditions and problems at hand.

A computing system accomplishes a task by taking information that may be stored, or may be streaming in from outside sources, performing some transforming operation on that information, assembling structures from that information and presenting the results to a user, either a human or another computing system. In the case of a human user, the display technology and methods significantly affect the insights that can be gleaned from these structures, and often constrain the nature of the structures themselves.

Such a system operates by passing and transforming information, using physical and logical elements that are connected by communication devices; these can be within a distributed computer system or in the same physical device. For example, a system may consist of servers and clients that are in different locations and networked by communication devices, and a browser within a client, where the browser and support software are logically connected within the client device and connected to the system via a client communications device.

Servers may be composed of server processors, server memory and associated communication devices which connect them for networked, perhaps collaborative processing. Clients may be composed of client processors and client memory with associated client communication devices. Computing systems may be composed of many servers and many clients in a network. A typical client is often singly connected to many servers in a server cloud, with a clear client-server boundary that delineates whether information is processed on a client processor or a server processor. A distributed system can be composed of at least one client and one server.

The computing elements each perform the assigned smaller jobs, potentially simultaneously, to accomplish the overall task. Aggregations of jobs can be seen by a user as applications, for example but not limited to rule evaluation, data retrieval or image recognition.

The system's overall task can be logically broken into smaller components of varying size; each smaller task can be assigned to a computing element. Typical computing operation involves messages among these smaller components, and many of these messages direct improvements in the structuring of the information.

Such messages may be from the user in a dialog with the computing system. These messages could be entered into the computing system by any input technology capable of creating or capturing user-initiated information. This information is then structured by the computing system and used as instructions in restructuring the stored or streaming information and/or new components of information to add to the structure.

Similar messages may originate in special purpose applications that perform a role similar to the human, but typically less nuanced and intuitive. These applications may be hosted in clients, servers or in special client communication devices.

Many elements, humans and applications may be simultaneously processing, structuring and sending information. Some components in the system will be concerned with creation of these messages in a compatible fashion; other components will be managing the flow of these messages; yet other components will be structuring information, and finally some components will be presenting the structures to humans and external applications.

Many additional messages will be entering the system from external information sources, providing raw and partially structured information. These can be from continuous or discrete sensors, for example television cameras or manufacturing plant monitors. They can also be from other computer systems that search, harvest and present information, like web crawlers. Or they can be other computing systems that have collected and structured information by independent means, and supply it to the system in question by subscription or query.

While systems such as the above already exist, they do not integrate their functions well. There are structural requirements to accommodate incoming streams and packets, structural requirements for sending messages to various components in the system, structural requirements for revealing meaningful insights to the analytical components in the system, and structural requirements for displaying information to users that conveys some or all of these other structures, based on the specific and temporal needs of the user.

Somewhat unrelated to these structural systems are certain constraints imposed by the cognitive abilities of the human user. Humans reason in certain spatio-temporal ways, some of which are learned, and some which are apparently due to inherent structure of the mind. An example of the former is the preference in certain societies with left-to-right writing systems to envision time flowing from left to right. The latter can be found in the way the mind seems to abstract relations in visual terms.

The mechanics behind these constraints are not fully understood, but their limits are well known. User interface designers try to accommodate these constraints in the design of user interfaces and information visualizations. However, these human cognitive strengths are rarely considered in the design of the information structures within the computing system. Significant improvement would result if the structures used by the computing system were informed by those apparently natural to the user.

Related to the design of such a computing system are emerging trends in representation technologies; these provide a greater range of options in how computing systems can structure and manage information internally. These insights result from modern advances in the mathematical foundations of logic, and include two-sorted logics where for example one logic reasons over context and another related but different logic reasons over facts in those contexts. An example of this is situation theory. These new logical techniques expand the internal vocabulary of what is possible to represent and reason about.

Finally, and somewhat unrelated are an expanded vocabulary of programming techniques. Functional programming has been known for some time, but its practicality has been limited. Functional code can be generated from mathematical structures, including mathematical structures that characterize logic. Logical forms such as the two-sorted logic described above can be characterized by these mathematical structures. Using the Curry-Howard-Lambek correspondence, the mathematical structures can be mapped to programming code that is provably correct. Functional reactive programming now provides a more practical means for the application of the Curry-Howard-Lambek correspondence linking mathematics and programming code as reactive transformation of information.

Reactive functions are modules of functional code that are assembled in a persistent fashion so that changes in the input of any function trigger a “reaction” in others. Effectively, the notion of continuous functions is introduced in the code. The resulting benefit is that the mathematical characterization used in the math-to-code correspondence can support more powerful logics, such as the two-sorted logic of situation theory.

The previous state of the art has not combined these advances so that matters concerning the cognitive display on the screen, the internal information structures of different kinds as described above, the programming code that addresses them, and the mathematical characterizations all coincide. This is because the disciplines involved do not normally interact with one another.

Also it is the case that at the level required, the mathematics, the logic, and the programming techniques are relatively unused because by themselves each presents apparently insurmountable barriers to practical use. Among other reasons, it is difficult to design a system where the visual conventions and logic have mathematical rigor.

Accordingly, there exists a need to improve knowledge representation, processing and display systems. Moreover, there exists a need to have more powerful instances in each of the domains: graphical user interfaces, situated reasoning and effective knowledge representation.

### SUMMARY OF THE INVENTION

The present invention is related to a computer system for knowledge representation, processing and display systems. In particular, the present invention provides a novel way of corresponding sets of information and displaying those correspondences in a user interface.

### BRIEF DESCRIPTION OF THE DRAWINGS

These and other embodiments are described by the following figures and detailed description.

FIG. 1 illustrates the hardware architecture of the system implemented in a single client.

FIG. 2 illustrates the components of a cell and dependent cells.

FIG. 3 illustrates adding a point to a cell.

FIG. 4 illustrates removing a point from a cell.

FIG. 5 illustrates adding a function to a cell.

FIG. 6 illustrates removing a function from a cell.

FIG. 7 illustrates the two logics, as in situation theory.

FIG. 8 illustrates the assembled reactive functions supporting the reactive transformation of information.

FIG. 9 illustrates the process of the system kernel's response to a query for information.

FIG. 10 illustrates the process of transforming data.

FIG. 11 illustrates the process of evaluating expressions.

FIG. 12 illustrates information represented in a tree-form information structure.

FIG. 13 illustrates an expression tree.

FIG. 14 illustrates a display of a session's historical expression trees.

FIG. 15 illustrates that history in the context of ontological zones.

FIG. 16 illustrates the generation of flow displays within those zones.

FIG. 17 illustrates a user interface linking several methods of typed links representing functional flows.

FIG. 18 illustrates an example haptic interface for manually modifying an element in an existing functional flow.

### DETAILED DESCRIPTION OF THE INVENTION

In the following detailed description, reference is made to the accompanying drawings, which form a part hereof and illustrate specific embodiments that may be practiced. In the drawings, like reference numerals describe substantially similar components throughout the several views. These embodiments are described in sufficient detail to enable those skilled in the art to practice them, and it is to be understood that structural and logical changes may be made. The sequence of steps is not limited to that set forth herein and may be changed or reordered, with the exception of steps necessarily occurring in a certain order.

Embodiments described herein are designed to be used with computer systems. The computer systems may include any computer system, for example, a personal computer, a minicomputer, a mainframe computer, or mobile devices. The computer system will typically include at least one processor, display, input device, random access memory (RAM), hard drive memory, communication device and possibly mass storage memory devices and subsystems, but may include more or fewer of these components. The processor can be directly connected to the display, or remotely over communication lines such as telephone lines, local area networks, or any other network for information transmission. The invention may be implemented with a variety of computing hardware. Embodiments may include both commercial off-the-shelf (COTS) configurations, and special purpose systems designed to work with the embodiments disclosed herein.

Embodiments may also be implemented with other hardware. For example, embodiments may be implemented using any of the following: field programmable gate arrays (e.g., field programmable gate arrays from the Altera Stratix® series, the Actel Fusion series, or the XiLinx Virtex-5 series); graphics processing units (e.g., gaming and multimedia graphics cards such as Nvidia® GeForce® 8800 series, or ATI Radeon™ HD 4800 series); or multicore architectures (e.g., contemporary multi-core processors such as the AMD Phenom™ series or Intel® Core™ 2 series); tablets such as Apple's iPad, iPhone or similar dvices. Certain photonic computing architectures such as those enabled by nonlinear optics are capable of performing the tasks described herein. As long as the hardware (or other computer medium) and software used is capable of performing the tasks required by specific embodiments, the embodiments are within the scope of the invention, and include embodiments of hardware and hardware modifications that are not yet known so long as the hardware has the task performing functions necessary to carry out the invention described herein.

The present invention provides a novel system that synthesizes object programming, functional programming, data-flow programming, mathematical logic and cognitive modeling. The synthesis allows a system to exist which provides for close alignment among the manner in which a user interacts with a system, how that interaction is logically parsed, how set-theoretic composition of the logic results, how that set-theoretic algorithm builds functional reactive flows and how those flows are structured for display to a user.

Such a system is reactive everywhere, adaptively and scalably supporting the reactive transformation of information. Disclosed embodiments provide for a distributed computer system using a client-server architecture. The disclosed embodiment applies paradigms from object (imperative) programming, functional programming, and data-flow programming. Using functional programming, which applies mathematical functions and avoids state data, allows the system to perform incremental computing, to be reactive everywhere, and to provide self-contained information transformation. Particularly, while the system and method of the present invention are described by the client-server architecture of the distributed computer system, the present invention can be implemented on other architectures, such as peer-to-peer or novel geometric topologies. Moreover, the present invention can be applied to other computing systems, and not only distributed computer systems—the system could even be practiced on a single computer.

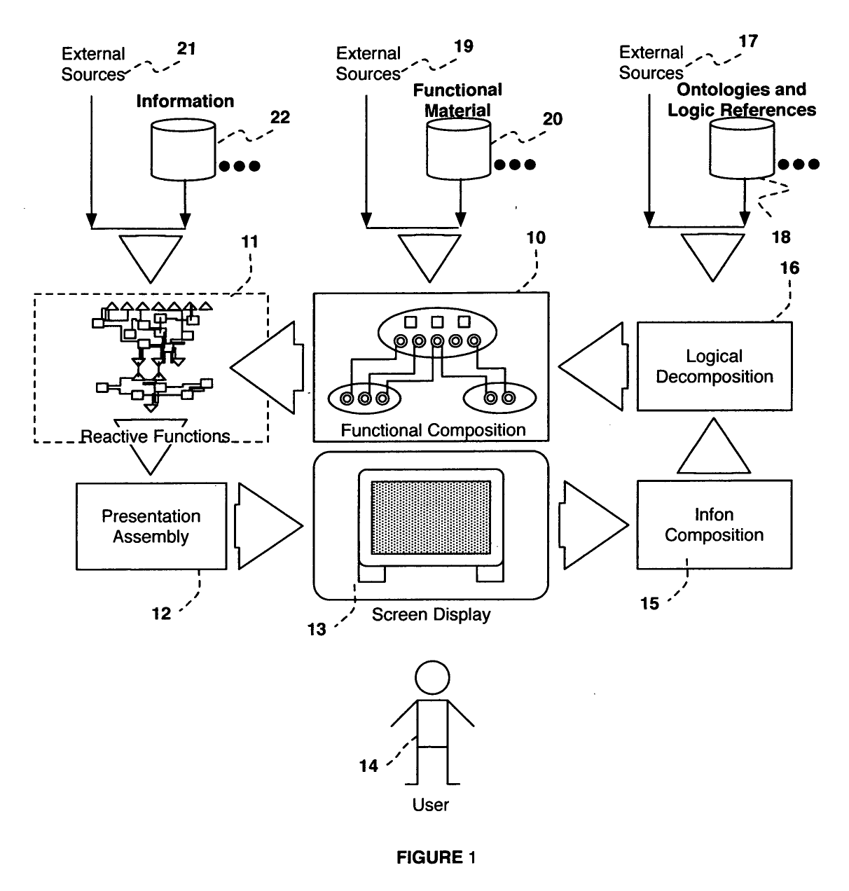

FIG. 1 is a first embodiment illustrating an integrated system consisting of a system kernel 10, which composes the functional reactive agents 11. The functional reactive agents structure the information as desired, including the details of the user interface via the presentation assembly module 12. A display device presents the screen display 13 to a user 14. The user can then interact in a natural way, perhaps by gestures and language that get translated into logical units by the infon composer 15. This can be via the human providing the infons directly and they are captured and aggregated by that composer, or the user can interact in whatever way is effective and that input is translated into the logical units by the composer.

These infons then constitute a complex logical statement to the decomposition module 16. By novel means, the system converts this logical statement into a set of cells. In doing so, it refers to a local reference 18, or can send queries to remote references 17 and/or receive dynamic updates to references already in use. The resulting cells are used in the functional reactive agent composer 10, already described. In a fashion similar to that already described, functions can be stored locally for reuse 20, gathered from remote services 19 or receive unsolicited, opportunistic updates.

The functions are created where necessary and assembled in a flow 11. This flow operates on information that is stored locally 22, remotely or which streams in 21.

An example use might be in an intelligence setting, for example as an analytical workstation for a defense analyst. Such an analyst may be the recipient of a large amount of streaming information, some raw from sensors and some provisionally annotated by collaborators 21. The analyst will have her own local information, including tentative conclusions 22.

The analyst will be interested in processing, filtering and composing the information in different contexts so that patterns can be discerned, inferences can be made and reports generated. The functional reactive flow 11, acts in this system as analytical programming code would in an ordinary system. It has two novel properties: it is reactive so far as the incoming information. As new information comes in, the “pipelines” of the reactive flow process it continuously so that the display 13 reflects real time. A second way the reactive flow 13 is novel is that it is reactive so far as the functions and functional composition. New information of various types can change the functions or their composition in real time.

This new information can come from the user directly, or as one of the automatic products from the presentation 12, which performs expert reasoning. It can as well come from remote systems making similar changes or providing updates 17, 19, 21. This updated information can be related to the base logic and ontology of the system 18, the functional composition rules or component definitions 20, or in terms of the information itself.

For example, a remote analyst can identify an object on a video that has been streamed to the user 14 through the functional array 11. The user will have already drawn conclusions based on prior knowledge of that section of the video. But with this new information 21, the reactive flow changes all of the inferences and display accordingly. This can be a very large and complex set of inferences and transforms.

A different kind of change may come from a remote analyst or service that modifies a method instead of an instance of information. For example, a remote service may supply a new or improved analytical method 19. This may in turn modify any of the functions or the way the functions are assembled into reactive flows 11.

Yet a third type of dynamic change in the system may come from a desire to evaluate the information in a different context. In this case, a different collection of information from 17, 18 might be selected. For example, the analyst may wish to analyze the information the way a religious fundamentalist would, in order to understand motives, intents and make predictions. Or she may choose to perform a different sort of analysis. An example in this case might involve a shift from analyzing the near term manufacturing and technical capability of a country to looking at long term agricultural and epidemiological perspectives. Making this shift requires changing root ontologies 18.

The analyst may further choose to evaluate the information in many contexts simultaneously and establish a higher level analytical context to understand the differences and intents.

Not shown in FIG. 1 are the feedback connections from the user 14, and the various modules 10, 11, 12, 13, 14 and 15, to the local stores 18, 20, and 22, and to remote users. Changes in one fundamental type can affect modifications in another. For example, new analytical methods supplied 19 or discovered and stored 20, may modify basic knowledge of the world in the local ontology 18.

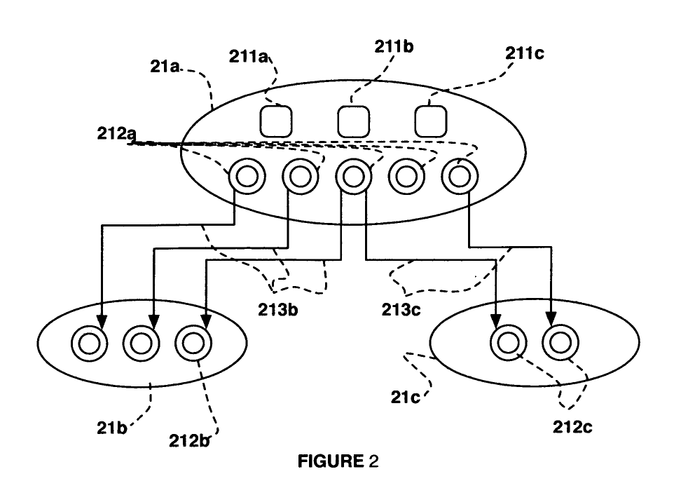

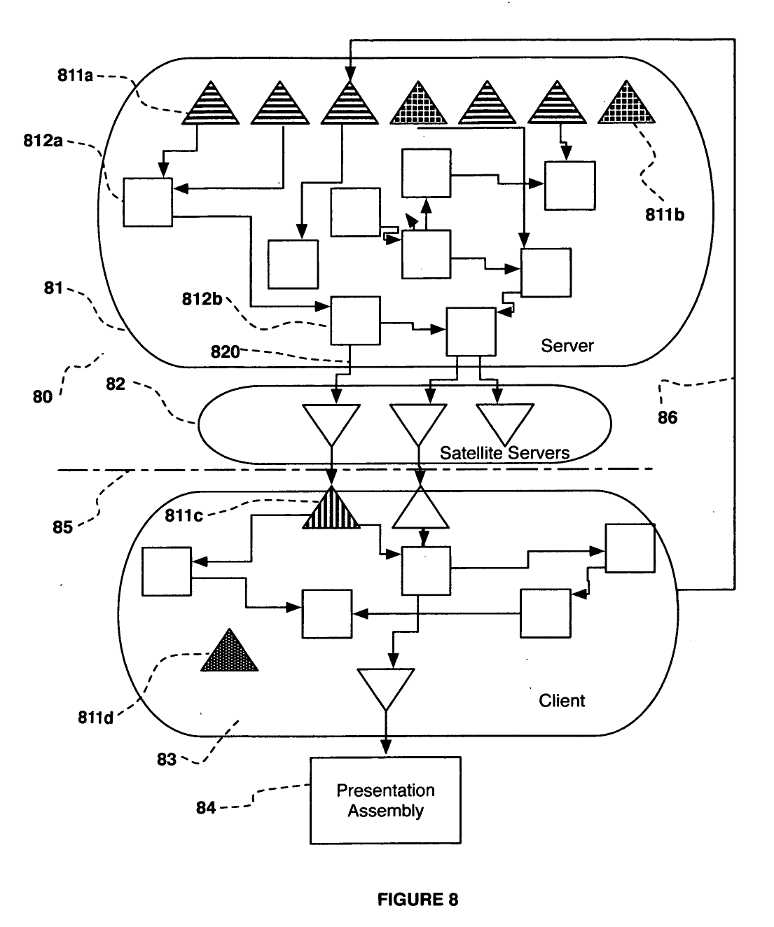

FIG. 2 illustrates the cells of the functional composition module 10 and their constituent elements. Cells 21a, 21b, 21c are the fundamental units on which this module is built. They are stored 20 or supplied externally 19. Cells map to sets, and the underlying mathematics that informs this module is set-theoretic; among other things, this allows for a functional programming paradigm to exist concurrently with object programming. Generally, there is one cell 21b, 21c per leaf of reactive function 811a, 811b, 811c, as shown in FIG. 8. Cells comprise points 212a, 212b, 212c which represent incoming information from 21, 22. Cells also are comprised of functions 211a, 211b, 211c, which can be performed on the points 212a, 212b, 212c. Arrows 213b, 213c emanating from points 212a to points 212b, 212c represent computational history as signals.

Cells, points, and arrows are created by and exist in both server and client hardware. For example, a cell 21a, 21b, 21c can be created by a signal from a client workstation computer, or by any one of the servers within the server cloud. Cells (and the leaves and transforms of information they build), are stored in memory 20. In another example, information stored on a server can be transformed by that processor into points, or points can be created by signals from client computers in response to transforms of information. Points are transformed by processing elements, and the resultant points are stored in memory. Furthermore, arrows can also be created by servers or clients. Arrows are dependency records which are represented by signals which may be manipulated to emanate to and from particular points. As it is known in the art, signals and their results may also be stored in memory.

Points 212a, 212b, 212c represent information. Cells in the top-most leaves 111a in the system contain base information to be manipulated. Information may be objects or streams, but may also be functions, facilitating the function programming paradigm. Points may exist in cells. Functions 211a, 211b, 211c may also create points 212b, 212c. Functions are only performed on points within in the same cell as the function. Functions, among other things, manipulate and transform information. All resultant points from performing a function are located in a single cell.

For example, in cell 21a, if a function 211c is performed as the result of a first signal, it is performed on all points 212a within that cell. Performance of that function results in the creation of a new cell 21c, as well as resultant points 212c which will populate the new cell 21c. Points 212b and 212c are resultant points created by functions 211b and 211c, respectively. Function 211a has been performed on all points in 212a, however, there may be no resultant points and a new cell (not shown) is created, but remains empty.

A second signal may trigger another function, 211b changing the resulting arrangement.

Performing the operation, creating the new cell, and creating the new points, results in the creation of arrows 213b, 213c. Arrows are a dependency record between points as well as between cells and capture the computational history (and the following computations) of information in the system. In the system, arrows can exist as signals, which can reside in memory. Arrows 212b, 212c emanate from source points 212a to target points 212b, 212c. Source points include the points arrows emanate from; target points are the points arrows emanate to. A point may be both a source point and a target point. Arrows 213b, 213c represent computational history and are fundamental to the system's reactivity and ability to do incremental computing. Arrows 213c show the computational history of the target points 212c from the performance of function 211c on source points 212a in cell 21a. In other words, arrows 213c give us the knowledge that points 212c were created because function 211c was performed on all points 212a in cell 21a. Likewise, arrows 213b give us the knowledge that target points 212b were created because function 211b was performed on all source points 212a in cell 21a. So, as explained, the arrow is a representation of how a point was created (its computational history), as governed by the logical decomposition of 16 rather than a link to information located outside of the cell. An arrow emanating from a source point to a target point shows the computational history of the target point is dependent on the source point. Said another way, all information in the cell is self-contained.

Taking a step back from individual arrows, it is valuable to examine the interaction among cells and arrows. All cells are aware of all arrows which emanate to and from itself. The cell's awareness of the arrows which interact with it give the cell awareness of the arrow's history (what function created the arrow, and to or from what cell that arrow emanates). This knowledge allows the cell to effectively see representations of dataflows within the system by analyzing its arrows.

Arrows allow for a reactive paradigm to exist in the system. Changes to information will propagate through the system and be displayed. Arrows provide a record of how points are derived, so points can be updated when source information or functional definition changes.

Arrows facilitate incremental computation in the system as signals are received so that small changes only require small transformations. In other words, the whole processing and display system does not have to be re-computed. With the knowledge provided by arrows 213b, 213c, when information changes in the system, the entire system does not have to be re-computed, but, only dependent information affected by the change has to be re-computed by finding where arrows emanate from and where they emanate to.

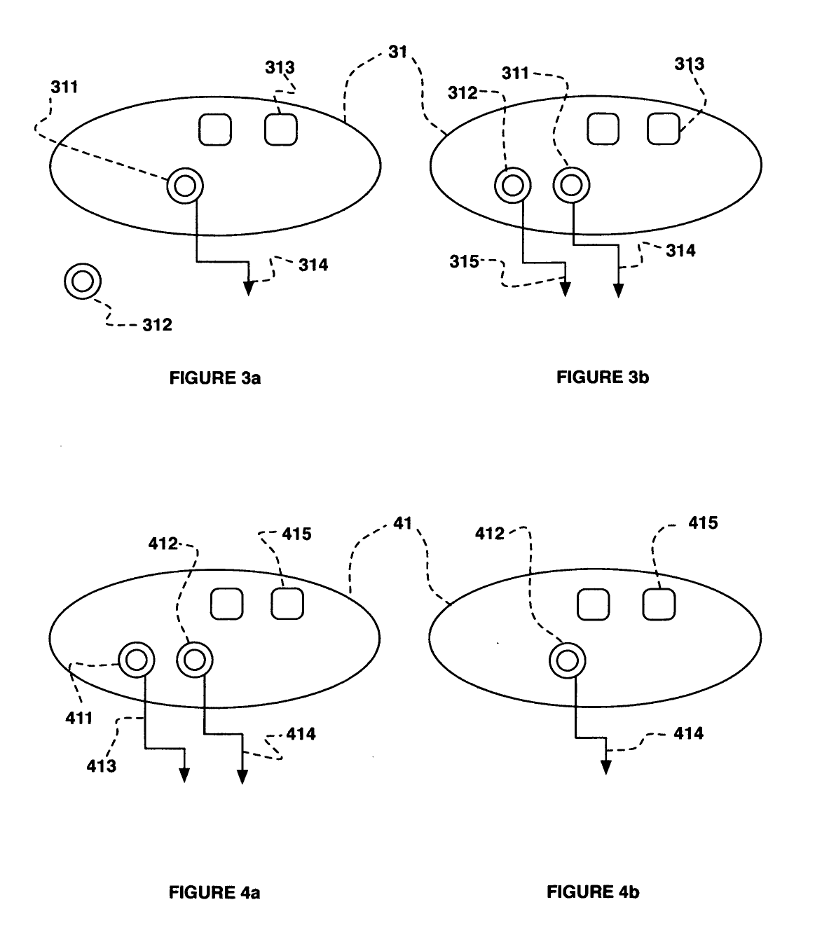

For example, incremental computation occurs when a first new point is added to a first cell triggered by a signal. All functions existing in the first cell should be performed on only that first new point, creating any necessary arrows and points. If a second new point in a second cell is created by that or a subsequent signal, then the process repeats itself for that second new point (all functions in the second cell are performed on the second new point). The process can repeat itself again, as necessary. A detailed description of adding new points to cells is described in FIGS. 3a-3b and its corresponding description.

A simplified set-theoretic, but non-limiting, example of FIG. 2 as applied to information as data follows. The five points 212a in cell 21a represent the information set of data {1, 2, 3, 4, 5}, respectively. Function 211a extracts all negative numbers. Function 211b extracts numbers less than or equal to 3. Function 211c extracts all odd numbers greater than or equal to 3. Function 211a has been performed on all points within cell 21a; as there are no negative numbers, there is no resultant transformation of data, and no points or arrows the result of function 211a exist. Function 211b has also performed on all points within cell 21a. As there are odd numbers, cell 21b, corresponding to function 211b, is populated with resultant points 212b. The three resultant points represent the data set {1, 3, 5}. Arrows 213b show the computational history of the resultant points. For example, the leftmost point in cell 21b correlates to the leftmost point in cell 21a. Both those points represent the number 1. The arrow emanating to the leftmost point in cell 21b represents the computational history showing the point was transformed from data in cell 21a as a result of function 211b. Likewise, function 211c is applied, and resultant points 212c representing the data set {1, 5} populate cell 21c, corresponding to function 211c. Arrows 213c emanating to points 212c show points 212c computational history from points 212a. This transformation of data from cell 21a to cells 21b and 21c can be processed on either server processor or client computers. Furthermore, the processing elements of either servers or clients compute the necessary transformations. The resultant data, the points, are stored on the memories of either the server or the client processors.

As illustrated in FIGS. 3-6, a variety of operations may be performed on a cell.

The operation of adding a point to a cell is shown in FIGS. 3a and 3b, showing a cell before and after a point is added, respectively. As shown in FIG. 3a, a new point 312 is to be added to an existing cell 31, with an existing point 311, existing functions 313 and existing arrows 314. As shown in FIG. 3b, point 312 is added to the cell. All functions 313 in the cell 31 in FIG. 3b are performed on the added point 312, resulting in a new arrow 315 emanating from the added point 312. The new arrow points to the cell the resultant transformation of data would be stored (cells not shown). There is no need to re-perform functions on existing point 311, which has previously been computed. This and other behavior is a result of the set-theoretic rules governing the functional composition.

A simplified, but non-limiting, example of FIGS. 3a and 3b as applied to information as follows. Point 311 (the point to be added) represents the number 2. Point 312 represents the number 1. Function 313 transforms data within its cell to extract all numbers less than 3. Arrow 314 represents the computational history showing point 311 has been transformed and a resultant point created. In FIG. 3b, point 312 is added to cell 31. After adding the point 312, all functions in cell 31 are performed only on point 312. So, function 313 is only performed on point 312, representing the number 1. As 1 is less than 3, a new point representing the number 1 is created, and placed in a cell corresponding to function 313 (not shown). Arrow 315 is created and represents the computational history showing point 312 has been transformed by function 313. This transformation of information instances can be processed and stored on either servers or client computers.

Another operation, removing a point, is shown in FIGS. 4a and 4b, showing a cell before and after a point is removed, respectively. In FIG. 4a, existing point 411 is to be removed from existing cell 41, the cell also comprising existing point 412, functions 415, and arrows emanating from the points, 413, 414. As shown in FIG. 4b, existing point 411 and corresponding arrow 413 have been removed. Removal implies deletion. All other components of the cell remain. Additionally (not shown), any points (not in a top-level leaf) which do not have any arrows emanating to themselves (as a result of arrow removal) are removed and deleted by this same procedure.

A simplified, but non-limiting, example of FIGS. 4a, 4b as applied to instances of information follows. Point 411 (the point to be removed) represents the number 1. Point 412 represents the number 2. Function 415 transforms information within its cell to extract all numbers with value less than 3. Arrows 413, 414 represent the computational history showing that points 411 and 412 have been transformed and resultant points created. In FIG. 4b, point 411, representing the number 1, is removed from cell 41. The corresponding arrow 413 showing the transformation of the number 1 via function 415 should also be removed. If the point arrow 413 had emanated to had no arrows emanating to it, that point should also be removed in accordance to this procedure. This transformation of information can be processed and stored on either servers or client computers.

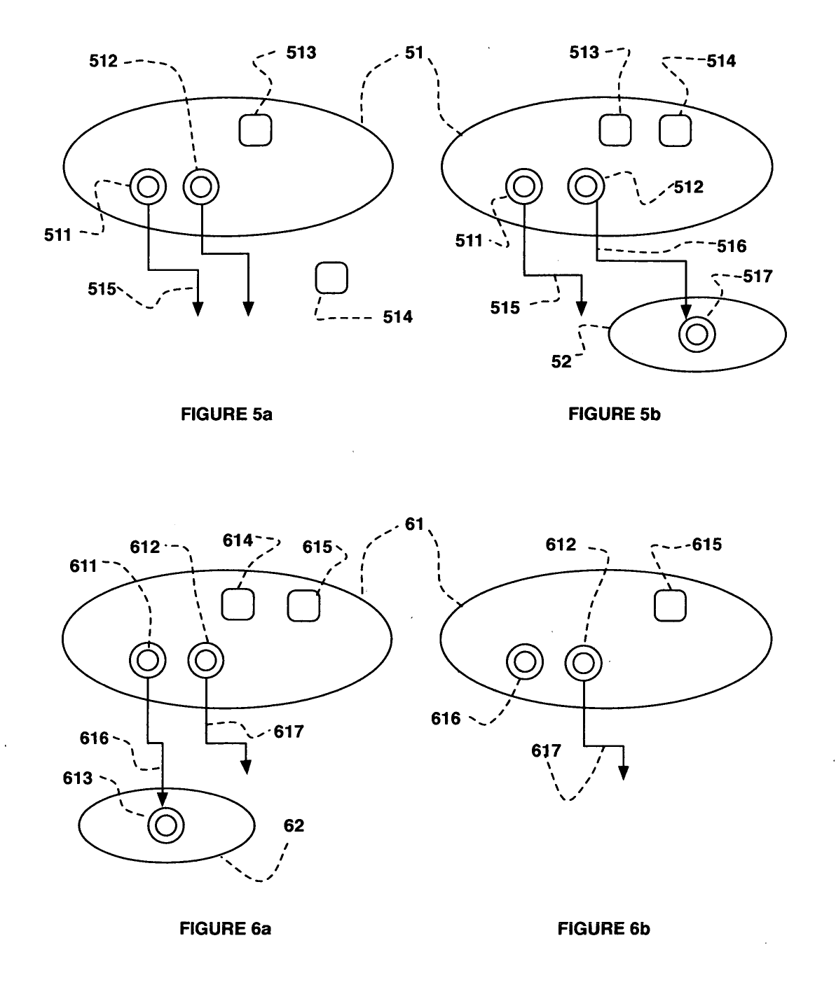

Another operation, injecting a function into a cell, is shown in FIGS. 5a and 5b, showing a cell before and after a function is injected, respectively. In FIG. 5a, a function 514 is to be injected into an existing cell 51, the cell also comprising existing points 511, 512, existing arrow 515, and an existing function 513. In FIG. 5b, injecting the function 514 into cell 51 results in the creation of a new cell 52. The injected function 514 is then performed on all points 511, 512. In this example, performing the injected function on points 511 and 512 results in the population of the new cell 52 by resultant point 517. A created new arrow 516 shows the computational history of point 517.

A simplified, but non-limiting, example of FIGS. 5a, 5b as applied to instances of information follows. Point 511 represents the number 1. Point 512 represents the number 2. Function 513 transforms instances within its cell to extract all odd numbers. Function 514 (the function to be injected) transforms instances within its cell to extract all even numbers. Arrow 515 represents the computational history showing point 511 has been transformed and resultant points created. In FIG. 5b, function 514 is injected into cell 51, and cell 52 corresponding to function 514 is created. Function 514 is performed on all points 511, 512 within that cell. As point 512 represents the even number 2, resultant point 517 representing the number 2 populates cell 52. Arrow 516 is created, emanating from source point 512 to point 517, and represents the computational history showing point 517 was created because function 514 was performed on point 512. This transformation of data can be processed and stored on either server or client processors.

Another operation, removing a function, is shown in FIGS. 6a and 6b, which illustrates a cell before and after a function is removed, respectively. In FIG. 6a, existing cell 61 comprises points 611, 612, functions 614, 615, and arrows 616 and 617. It is noted that arrow 616, cell 62 and point 613 are all the results of the performance of function 614. In FIG. 6b, function 614 is removed, hence all arrows created due to function 614 are also removed. Hence, arrow 616 is removed. As point 613 no longer has any arrows emanating from it, the point is removed (in accordance to the point removal procedure, described above) Additionally, cell 62, corresponding to removed function 614, is removed. Cells, points, and arrows which have been removed are necessarily deleted.

A simplified, but non-limiting, example of FIGS. 6a, 6b as applied to instances of information follows. Point 611 represents the number 1. Point 612 represents the number 2. Point 613 represents the number 1. Function 614 (the function to be removed) transforms data within its cell to extract all odd numbers. Function 615 transforms instances within its cell to extract all even numbers. Arrows 616, 617 represent the computational history showing points 611, 612 have been transformed and resultant points created. In FIG. 6b, function 614 is removed from cell 61. Arrow 616 represented the computational history showing point 613 was created from performing function 614 on cell 611. Point 613 was a resultant transformation of information from function 614. Cell 613 had been created to be populated by resultant points of 614. As function 614 is removed, the corresponding arrow 616, point 613, and cell 62 should all be removed and deleted. This transformation of information can be processed and stored on either server or client processors.

A separate operation is garbage collection. Garbage collection removes any cell where all functions have been removed from that cell, unless that cell is specifically denoted as a cell with only points. The removed cell and points are deleted.

A few rules are observed during cell operation, governed by set theory as applied to logic by means well known in the art. Arrows from multiple points may emanate to a single point. Changes to a cell may potentially affect all dependent cells. In general, the resultant points of a function populate a single cell created to store the resultant points of that function. However, it is possible for a function to loop back within the cell; i.e., arrows emanating from a point emanate back to that point. Each point is uniquely identifiable. It is possible that an empty cell exists; i.e. a cell is created for a function to fill with transformed data (points), however, the function results in no resultant points. There exist primitive functions which perform basic cell operations, including creating cells. Furthermore, primitive functions pre-exist in cells—that is, they do not have to be “injected” for a cell to perform the particular functionality. Other cell functions which exist may be filtering, mapping, ranging, inverting, etc. Those other cell functions are not pre-existing, and may be injected into a cell when performance of a particular function is desired. The requirement for or source of such a particular function can be on the client or on a server, under the control and knowledge of the system or unexpectedly supplied

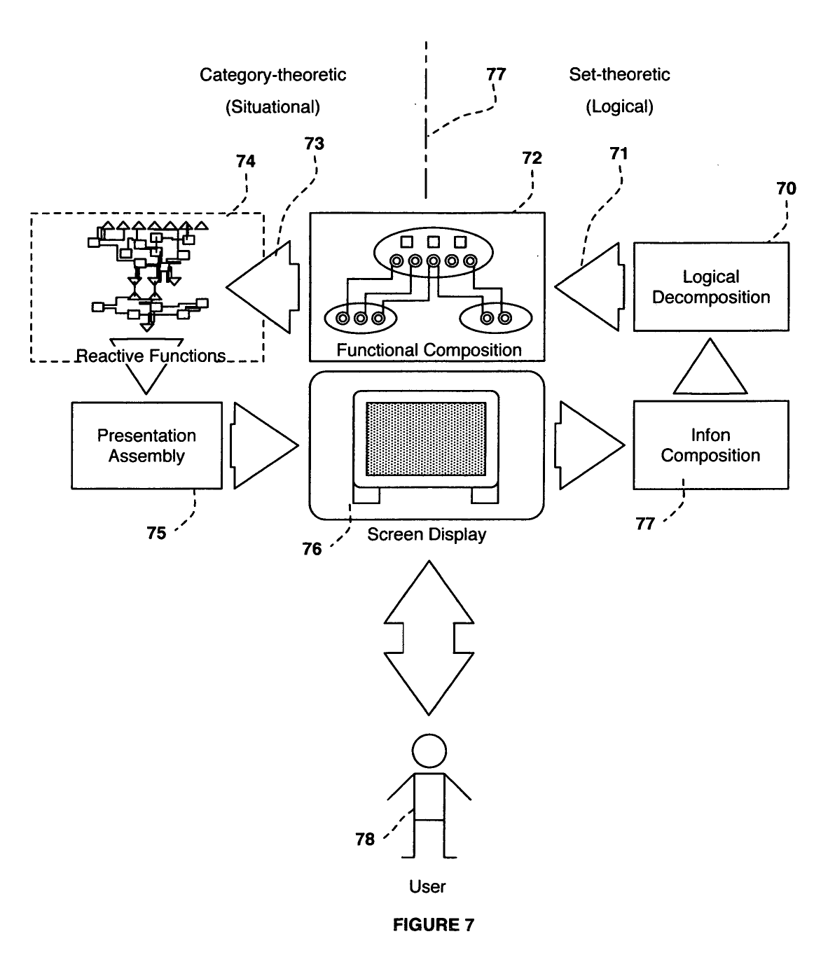

Arrows allow cells to keep track of computational history. The underlying formal dynamics are indicated in FIG. 7. Inputs from the user 78 are in a structured logical form. Operations among 75, 76, 77 and 78 are logical in the sense well known in the art. These can be supported by common reasoning and display infrastructure such as provided by Windows, Unix, Macintosh and GPU suppliers through systems such as OpenGL and OpenCL. There are few restrictions on the logical conveyance and operation at this level, and advanced input devices can readily be supported providing that they use computational methods that are logical. This can include advanced input methods such as haptics, holograms, speech and eye, muscle and brain wave sensors. Arrows enable the undoing or recomputation of past computations, and the comparison of past computations to current computations. The use of cells, points, functions, and arrows allows the system to have the ability to inject/remove functions or add/remove points into cells such that the changes propagate throughout the system in real-time, while the system is functioning. This can be centralized or decentralized and incorporate components and operations not explicitly shown.

FIG. 7 reproduces elements of FIG. 1. Operation at the level of modules 70, 72, and 74 are novel. As just described, the functional composition 72 is guided by instructions provided by the decomposition of the logic into elements that can inform the process just described, with cells, points and arrows. This conforms to axiomatic rules concerning set theory and logic which are well known in the art.

The reactive functions 74 employ the functional programming paradigm. It is well known in the art that functional programming can be formalized in category-theoretic terms. Notwithstanding the fact that information flowing through the reactive array 74 is processed by set-theoretic logic, and further notwithstanding the similar fact that operation of constructing and managing the cells by the translation of the inputs from the user is performed by using set-theoretic logic 70, 71, 72, the relationship 73 between the cells, points and arrows 72 and the reactive array 74, is governed by category theory. A dividing line 77 separates these two logics; in this fashion, the system is capable of supporting a two-sorted logic. Such logics are known art; they are often employed for reasoning in context, where one logic reasons over context and the other reasons over facts and inferences performed in those contexts. A well known implementation of two-sorted logic for general reasoning is situation theory.

An example of situation theory may involve an analyst who wishes to evaluate a set of facts two different ways. Perhaps one way would be as a fact based engineering specialist may reason about the facts, performing certain inferences. A second way might be how a third world religious zealot may reason about the same facts in a different context, drawing different conclusions. In each case, a different ontology governs the creation of the cell array 72, resulting in a different functional array. The two-sorted behavior is apparent in the logic 70, 71, 72 that reasons about another logic 74.

It is of course possible to have a third ontological context, one in which a third reasoner sees, understands and reasons about the difference between the engineer and the zealot.

FIG. 8 is a first embodiment illustrating a category-theoretic system kernel 80, the framework for managing information flow, implemented using a client-server distributed computer system. The basic components of the system 80 include the server cloud 81, the server-client boundary 85, the client 83, presentation assembly 84 leading to the user interface and the logical link between the client 83 and the server-only leaves 811a. The model further comprises leaves 811a, 811b, 811c, reactive transformation of information 812a, 812b, and consumers of information 813.

The server cloud 81 is a logical representation of a single server, but may comprise a plurality of servers networked together with communication devices. Servers are computing devices which host and perform actions on information. The server cloud 81 can communicate with satellite servers 82. Satellite servers 82 may be servers with information storage and information access capabilities. Satellite servers can communicate with clients 83 to provide clients with data. Clients can be any type of computing device, including personal computers, embedded processors including those in military systems, smart phones, or other mobile devices. Clients may request services from servers, but may also perform actions on data. Clients provide presentation assembly services 84 which provide users information displays and the ability to manipulate information. While only one client 83 is shown, the system may comprise a plurality of clients.

As it is well-known in the art, both servers and clients comprise at least one processor and memory. In the present invention, servers and clients both perform functions by a processor which processes and transforms information delivered from elsewhere and information stored in their memories. As will be discussed below, the processes of performing functions on information are accomplished through functional programming and incremental computing.

Leaves 811a, 811b, 811c are discrete, logical containers, each containing information and functions. Server processor-only leaves 811a exist only on a server and store information that are the basis of transformed data. Server processor-only leaves 811a can be the top-most layer of leaves in the system. The top-most leaves often contain information which the system manages and manipulates. There are leaves 811b existing on both clients and servers; those leaves contain functions and information which both clients and servers require access. Leaf 811c is a bridge, which simulates having a direct line from the server to the client. Bridges are set up to traverse the server-client boundary 85 so that the server and client can communicate. There are also client-only leaves 811d, containing functions and information that only clients will need to access. Changes to leaves propagate throughout the system kernel 80, discussed in further detail below. Leaves can comprise any information structure, for example, numbers, strings, Boolean values, or any object in an object-oriented system. Additionally, they can comprise functions. Finally, they can comprise cells, which are reactive (changing) values, as described below.

The system kernel 80 further comprises transformations of information 812a, 812b. Transforms of information contain information resulting from a function performed on other data. Transformations of information 812a, 812b are self-contained, and are stateless. They can exist on servers or clients. They provide views of the database, and importantly, can be reactive to changes in the database. Transforms of information comprise cells, described in FIGS. 2-6.

Information in transforms of information 812a can be further processed and transformed resulting in other transformations of information 812b. Because such transformations of information 812 are self-contained, resulting information is passed throughout the system via messages passed along, for example, path 820. This architecture allows the system to thereby function in a distributed manner, as in a distributed computer system where each component is independent and self-sufficient. This allows for scalability and adaptability to components added to or removed from the system without affecting the system's functionality.

The architecture further comprises consumers of information 813, which are also bridges, traversing the server-client boundary so that the server and client can communicate. They can act as repositories to store and pass along data. Example of repositories that store and access information include storage devices such as hard drives, RAID devices, other information servers, and mass or discrete storage units.

The client 13 provides at least one user interface presentation service 84 which, among other things, allows a user to view the information on the system. The user interface presentation service 84 also allows a user to query the system and view the result. The user interface allows a client user to manipulate leaves 811a, 811b, 811c through the client 83 (and hence, propagating changes throughout the entire system kernel 80).

The server-client boundary 85 is the separation between server and client. The boundary is set to optimize functioning of the system, taking into account factors including bandwidth, latency, computing power, memory, and security rules. The factors are considered because the boundary 85 must react to changing conditions in order to maximize efficiency when performing computations. This allows for a system novelty in that there is flexibility where the boundary is set. That is, the system 80 may decide to assign the responsibility for a transformation to either the client or server, in a way “moving” the sever-client boundary 85. For example, transformation 812b is computed by the server, but, by moving the server-client boundary to encompass transformation 812b, the transformation would be computed by the client.

The link 86 between client 83 and servers 81 allows the user to interact with the system and change values on the server. This is accomplished through the user interface presentation service 84 coupled to the client 83. There also may be additional user interfaces 84b other users concurrently access, which may run on the same or on separate clients. All users may use any user interface 84a, 84b to view the current state of information, or to query the system, in real-time.

FIG. 8 also illustrates the system's reactivity where changes to leaves in the system will propagate throughout the whole system. For example, the system may currently have a particular representation of information in the user interface presentation service 84. However, the user may wish to change information in the server-only leaves 811a. If the information in the server-only leaves 811a is changed, then the resultant transformation of information 812a may change. The change to resultant transformation 812a may also affect the resultant change in transformation of information 812b, and so forth down the model, over the bridge between consumer of information 813 and leaf 811c, back down to the user interface presentation service 84. Those changes propagate throughout the system, but only effect components related to the change, potentially resulting in a change to the final display of information on the client 83 and the user interface presentation service 84. It is important to recognize that the change to the top-most leaf, in this case the server-only leaf 811a, results in changes throughout the system, and are shown in real-time. Because the system reacts to changes in real-time and all entities connected to the system can access the most up-to-date information concurrently, the system facilitates a reactive paradigm. Likewise, a change in leaf 811c would force a change thought the system, changing any transformations dependent on the leaf.

It is also important to note that embodiments can easily be created that follow an autonomous agent self-organizing paradigm. In this approach, the feedback loop 86 will carry additional information about “reward” for value added by each function. This feedback loop would in this case additionally extend to fundamental information sources 17, 18, 19, 20 as well as the sources 21 and 22 of the embodiment described in the figures.

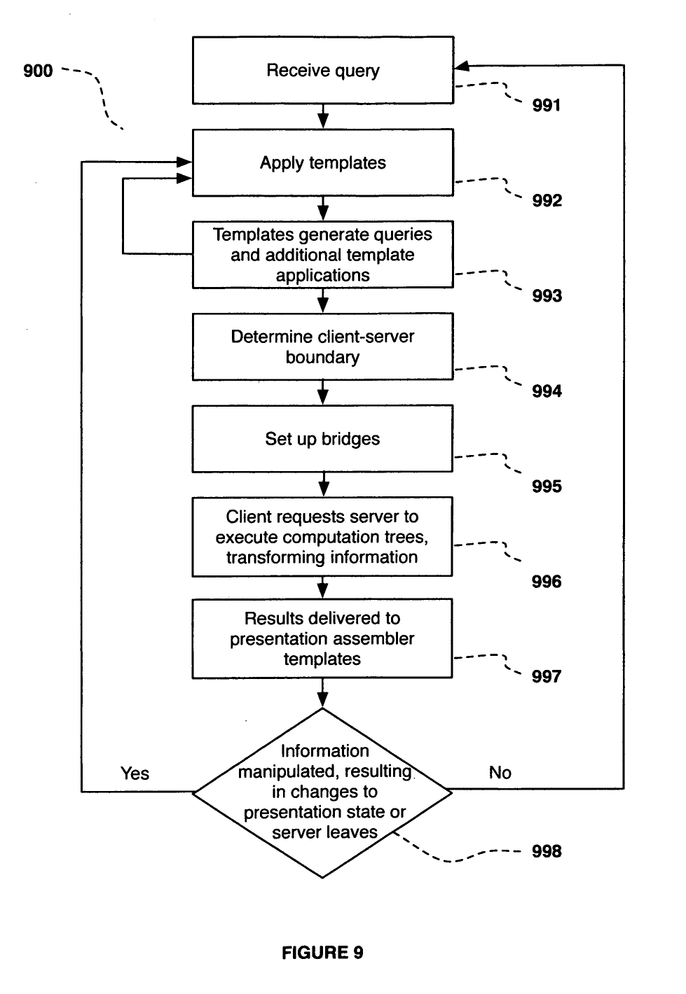

FIG. 9 shows the system in an exemplary operation 900 responding to a query. Generally, the query creates a computation tree which at least selects a top-most leaf on which to perform transformations, resulting in propagating transformations throughout the system, finally flowing back to the user to view the results of her query.

In step 991, the client is open and a query is received. Opening the client initiates a session with the server. The client starts at an initial local state, which is either a default start state or a saved state from the last time the client was closed. The local state includes information such as user interface state data (e.g. mouse position, window position, specific information to be viewed). The local state can be a leaf on the client 811c. The client comprises at least one user interface which can accept a user query for the system to process. A user query may be created expressly or implicitly.

In step 992, a main template function, residing on the client, is evaluated. A template function is a function which provides an output and has functions to show information on an on-screen display. The template function is reactive to changes in the system so that changes within the system automatically update the template function. such a template function can also query the system. The main template function is aware of the local state. The main template function is also aware of top-level leaves which exist on the server. As mentioned before, top-level leaves are leaves which contain information forming the basis of computations.

In step 993, evaluating the main template function creates computation trees from queries. Computation trees are the expressions the system uses to respond to queries. Portions of computation trees can be created using the template function. Other portions of computation trees are built when expressions are evaluated and transformations of information are processed. The full computation tree leads to the result of the query, however, the main template function on the client may only do part of the process of evaluating the query by starting to create a part of the computation tree.

In step 994, the system dynamically determines the server-client boundary after the query is made, but during the process of evaluating the query, using factors including bandwidth, latency, computing power, memory, and security rules. This determination can be made either by the client, or by a negotiation between the client and the server. The server-client boundary logically separates the servers and the clients in order to maximize efficiency of the system. In step 995, bridges across the server-client boundary are built so the client and server may interact.

In step 996, the servers are accessed to compute its share of computation trees. A computation tree can be, for example, the top-most leaf on which transformations are performed, wherein those transformations cause changes that propagate throughout the system. The computations and transformations of information begin at the top-most leaves. The system then begins to make “transformations of data” as needed, and sets up any connections between leaves and transformations as necessary. Transformations of information begin at the top-most leaves and servers, and then propagate down to the clients

Once all necessary transformations of information are completed, and the result of the query is completed, the result reaches the client, passes the information to the user interface, and the results are drawn to the screen of the user interface in step 997. If the user makes a change in the user interface, the local state may be changed, hence the leaf corresponding to the local state is changed. The change in the local state potentially affects the computation tree, and that change propagates throughout the system. The user may also make a change to a leaf on the server which was included in the computation tree. That change should also propagate throughout the system. There may be multiple users on the system; any user may make any change at any time (e.g., user B may change a leaf which user A's query depended on). Any change to the system propagates throughout the system, affecting all users of the system. To react to changes in the user interface, or in the leaves, the system loops back to step 992 to propagate the changes throughout the system. Otherwise, the system waits for a new query, and loops back to step 991 to receive the query. Changes that propagate throughout the system literally change and transform the information that reside on servers and client computers. Data, represented and stored as signals in the memory of server and client computing elements, is updated and recalculated as the system propagates updated information throughout the system.

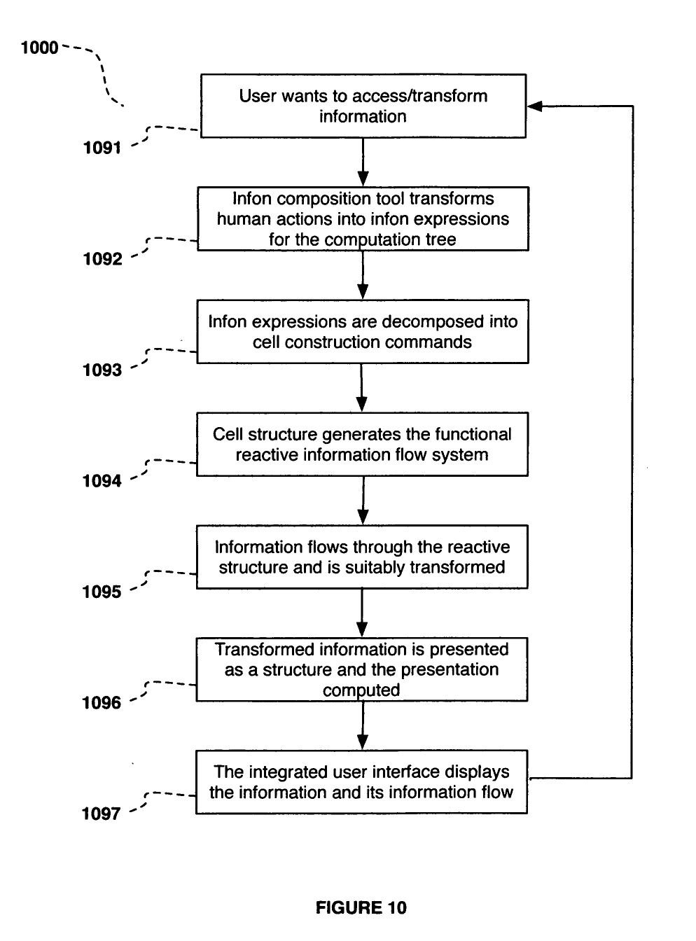

FIG. 10 details FIG. 9's step 996 of making “transformations as needed.” In step 1091, a user is requesting some operation on the information in the system. Step 1092 translates the user actions into infons if they do not come from the user in that form. In step 1093, the system, as described above, transforms the user's request for information into an expression represented as a computation tree.

In step 1094, the expression is transformed into a data-flow system consisting of reactive functions. Transformations are created by performing functions on points within cells using the functional programming paradigm, so that functions performed on cells may use other functions as their arguments.

Step 1095 shows the assembled functional flow transforming information that flows through it. In step 1096, the transformed information is further transformed to accommodate additional functions associated with creating the user view. The functional array for this step can be tailored to the specific situation of the user, her cognitive strengths and analytical needs.

In step 1097, the resultant transformations are displayed to the user.

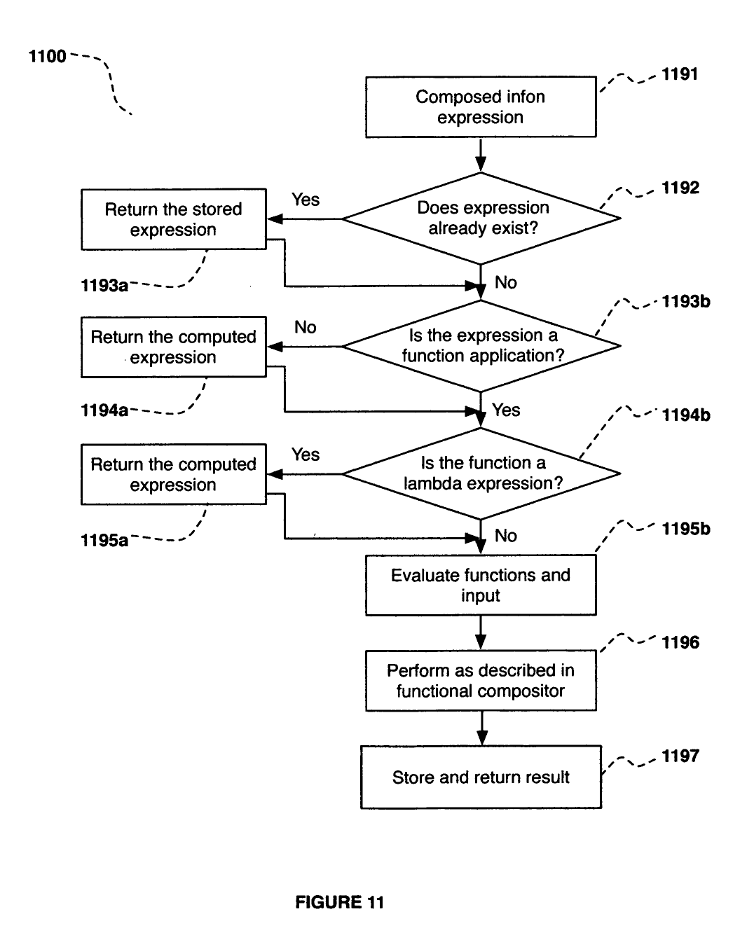

FIG. 11 details the process of evaluating expressions, creating the computation tree, in part using lambda calculus. Step 1191 begins with the expression to be evaluated. The expression to be evaluated is generated from user queries. Expressions are defined by literals (numbers, strings, Booleans, and other data structures), objects, primitive functions, and variables that are introduced in lambda expressions. Step 1192 determines if the expression has already been evaluated by checking if the required functions have been performed yet. If it has, then the result of the already-existing expression can be returned at step 1193a. If the expression has not already been evaluated, it must be determined if the expression is a function application or an information point at step 1193b.

An expression is a function application if it has a function and an input. If it is not, then the expression can be returned at step 1194a. A function is either a lambda expression or a primitive function, and is determined at step 1194b. A lambda expression is a known method to represent a function and define the transformation that the function performs on its arguments. Functions can be passed as arguments, or returned as results. The use of lambda expressions helps to facilitate the kernel's functional programming paradigm. If it is a lambda expression, then a beta reduction must be performed at step 1195a. A beta reduction is the process of computing the lambda expression (i.e. applying functions to their arguments). Beta reductions are performed through substitutions. Substitutions are the process of replacing all occurrences of a variable by an expression. The result of the beta reduction should be evaluated at step 1195b.

If the function is not a lambda function, it is a primitive function and the system should apply the primitive function to the input, and evaluate that at step 1195b. Necessary functions are injected and necessary cells are created. At step 996, the system should perform the transformation of data, as described in the cell implementation, which has been described above at step 976. The transformation of information step entails processing points within cells by functions. Finally, the result of the evaluation and transformation is stored and returned at step 1197.

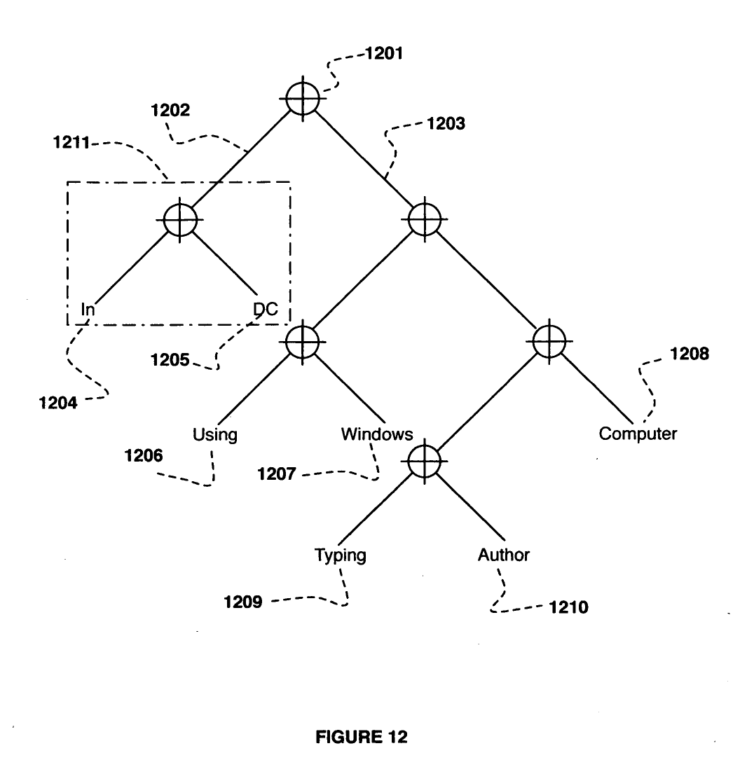

FIG. 12 is an example of an information structure in the form of a tree using infons to represent information. This figure is not necessarily part of the system, but, serves as an example of how information may be stored, and its subsequent processing, within the system. Infons are a way to decompose a simple sentence structure. An infon has a relation (e.g. a verb) and arguments. For example, the sentence: “An author is typing,” composed in infon form is: <typing, author>. Furthermore, as sentences get more complex, infons may be nested. So, the sentence, “An author is typing on a computer,” in infon form is: <using, computer, <typing, author>>. Infons may be even further nested. So, the sentence, “An author is typing on a computer in DC,” in infon form is composed: <in, DC, <using, computer, <typing, author>>>. Nesting can continue without end.

The last example sentence is represented as a tree-form information structure, as shown in FIG. 12. The tree comprises objects 1201, 1211. Objects include the grouping of items, including the words “In” 1204, “DC” 1205, and Cons 1201, shown in grouping 1211 (represented by the dashed, lines). All objects have the properties upLeft and upRight, which are a set of Cons. Cons 1201 are also objects. Cons are objects which comprise (in addition to upLeft and upRight) a left object 1202, a right object 1203, and a truth value (not shown). A truth value may be necessary to evaluate whether information is reliable or not.

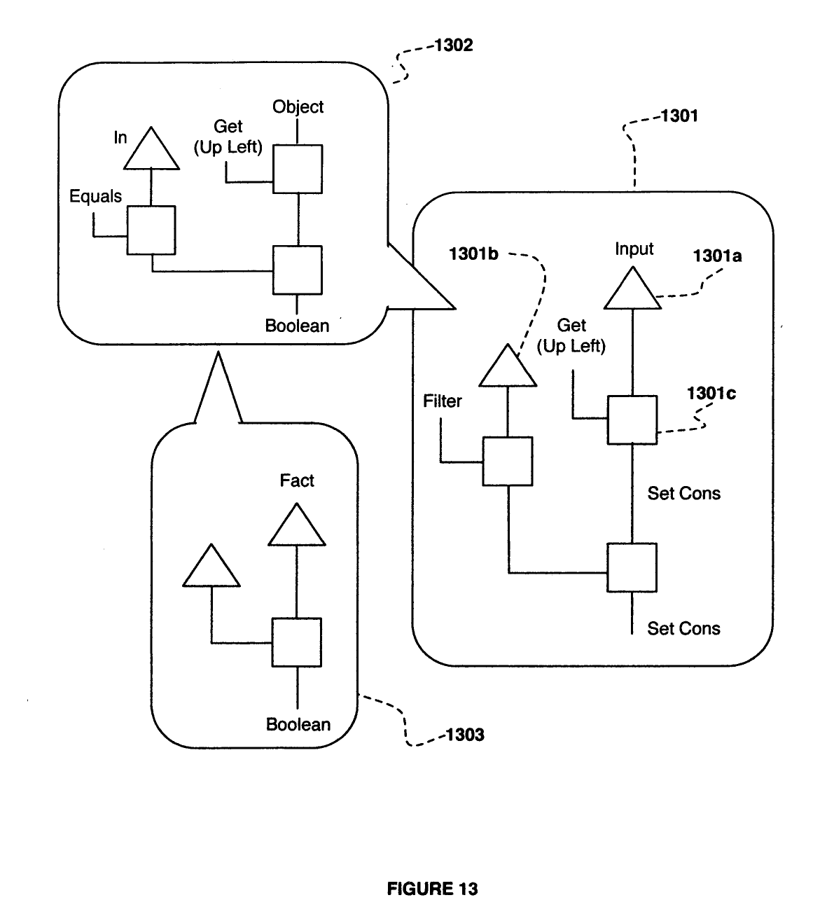

FIG. 13 is an example of a computation tree. Grouping 1301 shows how information is transformed as they go through leaves and transformations. For example, leaf 1301a contains information to be transformed at transformation 1301c, and so forth. Grouping 1301 takes in an input 1301a as well as a function 1301b to create the computation tree 1301. Grouping 1302 is an example of functional programming, as it shows that input can be in the form of not just data, but also can be a function. In other words, leaf 1301b can be the transformations performed by grouping 1302.

Furthermore, grouping 1303 shows a substitution, which is applied if necessary, as described in step 1195a of FIG. 11.

An example of the system managing and manipulating information to respond to a query follows. In this example, a user queries the system to find out where an author is typing.

On top-most leaves 811a the following information is stored: “An author is typing on a computer in DC.” That information is stored in infon format, which is represented by the tree shown in FIG. 12. That tree is stored as points 212a existing in a cell 21a.

A user accesses the user interface 13 to make a query to the system, to find where the author types. When the user accesses the system, it renders whatever database information it can to the user and the user submits the query to the user interface comprised in total of 12, 13 and 15 as described in step 995. The system then determines the server-client boundary 994 in response to the query. Then, the client 83 applies template functions and requests the servers 81 to create computation trees, as described in step 996, via a link to the server 86, which picks the appropriate leaves 811a containing the information “An author is typing . . . ” Based on the user's query, the leaves will start performing functions on the data—i.e., making transformations of information as needed and evaluating expressions, as discussed in step 996 and steps 1191-1197, respectively.

The system may need to add functions in order to perform the query. In that case, in server leaf 711a, a function is injected into the cell residing in that leaf, in accordance with FIG. 6, as described above. The result of that function creates new cell 62 and new point 617. The new cell and new information correspond to transformation of information 712a. In response to the newly created transformation of information 712a a point must be removed from transformation of information 712a. That point is removed in accordance with FIG. 4, as described above. The removal of the point is yet another transformation of information 712b. The resultant points are messaged down to the consumers of information 713 which pass those points down to client leaves 711c. At the client, yet another cell function may be performed, for example, filtering. Finally, after that transformation, the result has been determined. The points are sent to the user interface 14a, which draws the result (“in DC”) to the screen, as described in step 997.

If the user sees that data she may determine some change must be made, as in step 998. If the user learns that the author was in DC, but now is in Boston, she will manipulate the data, using the user interface 12, 13, 15. The change is relayed up to the appropriate server leaves 711a. This change in information changes the top-most leaves 711a, which in turn will affect all the transformations of information described above (but only the transformations which were necessary to the query). The system adapts to the change in information by following any arrows emanating from affected leaves 711a, and updating (adding, removing, etc) the arrows, as well as the resulting transformations of information and leaves (comprising cells, points, functions), as necessary. The transformations, etc, propagate through the system, and the user should see the result of her query change from “in DC” to “in Boston” in light of the new information.

In parallel, another user, using another instance of 12, 13, 15, could have been observing, in real-time, all the interactions, and manipulations that the other user 14 using screen display 13 has made. Similarly, the same user could adopt parallel perspectives where she is reasoning about information and at the same time reasoning about how she reasons about that information. This is a common scenario where a consumer of analysis wants to know not only the results, but how those results were obtained. This is why two-sorted logic is commonly desirable and one reason the system supports it.

The user will, therefore, want to see this multi-context structure in the user interface. A number of embodiments are possible, given that many of the leaves, functions and ontology entries might be concerned with cognitive and display matters. The following figures show one embodiment of a display that provides these structures. This embodiment builds on and extends the invention of U.S. patent application Ser. No. 12/105,143 of Apr. 17, 2008 (20080288856).

Features of that invention have panes that can denote different collections, ontological slices or contexts of information. Within some panes are outlines that allow cloned leaves. This allows the representation of tree structures characteristic of FIG. 12 as well as directed acyclic graphs characteristic of the flows in FIG. 8. Directed acyclic graphs are represented in outlines by the use of “clones,” where a node can be placed at multiple locations in the hierarchy by means well known in the art.

The links defining the hierarchy in each of these outliner panes are generally of one type, for example “child of” or “contained in.” A feature of the referenced patent is the ability to display and define typed links of arbitrary kind. In the embodiment described here, those links correspond to the functional transforms 820. The ability to define a new link, and/or link type by dragging and dropping by means described in the referenced patent accomplishes in the embodiment described here the effect of direct user intercession in the processes controlled by the functional composition.

Simultaneously, every functional relationship in the described embodiment has a typed link that can be hidden or displayed by the user as described in the referenced patent. The embodiment described therein is implemented in functional XSL and JavaScript, but as described here, any functional programming technique can be used. Examples are Haskell, Erlang and Ocaml.

In this context, the user interface of the referenced patent provides a means of displaying every element of the structure illustrated in FIG. 8. It provides a means of displaying multiple contexts through the use of individual panes. Furthermore, it provides a means for direct user modification of the construction methods used in the function composition 10 of FIG. 1.

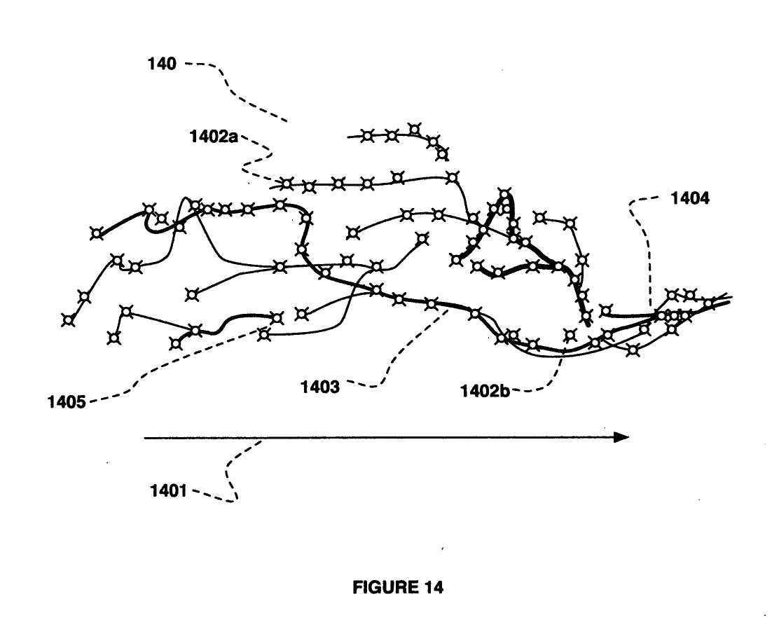

FIG. 14 illustrates an extension to the referenced user interface patent as employed in the example embodiment. This new element displays the trees and flows combined in a superimposed image 140 of all instants of tree fragments as an aggregated display over time. As the dynamics of the functional flow builds and changes the history and reinterpretation of the transforms, the display reflects these changes over time.

In this display, instances of nodes 1402 are registered on a left to right horizontal time line 1401. The path of the single node through time is shown as a curved line, with secondary lines showing key dependencies. Single nodes are replicated, with an earlier instance 1402a existing in the same flow as its later occurrence 1402b. The thickness of the line may be used to show the relative strength the node plays in the context as a measure of persistent influence.

Other elements of the tree are shown in this embodiment. Branches 1404 in the figure indicate times at which a specific function or persistent group of functions is reassigned to or replicated in a new location in the functional flow. Discontinuities 1405 show an influential function that for a period were not prominent or were eliminated from the flow.

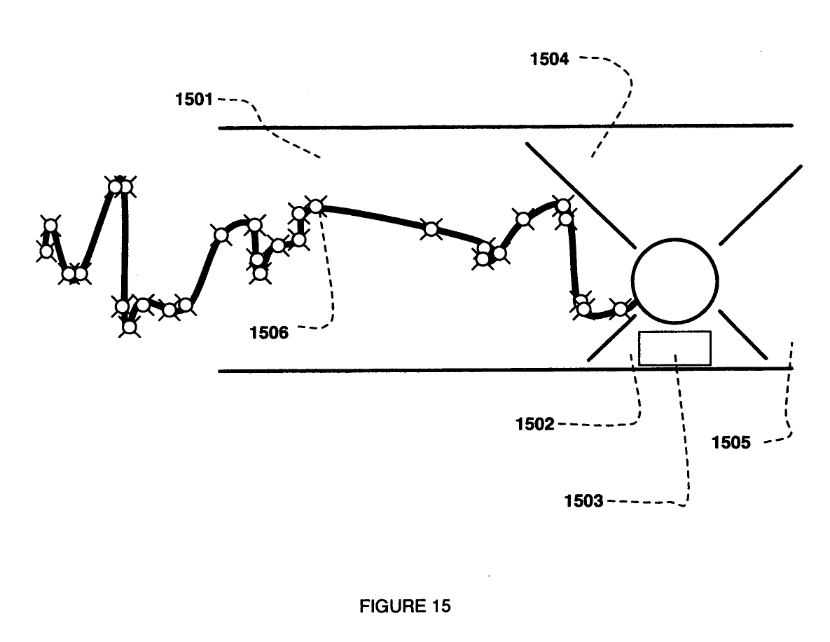

FIG. 15 illustrates ontological zones and the means by which a vertical position can be computed. The left zone 1501 as previously described is a progressive history of past states. The bottom zone 1502 is the instance of appearance of a new item of information. In the illustration, this information 1503 is displayed literally because it is a frame of a video. This item of information corresponds with the leaves of the functional flow. In other cases, it may not necessarily be something that is intuitively readable by a human, so denoted by a data item or icon.

The zone at the top 1504 corresponds to the leaves that are stored in the ontologies rather than leaves that originate in information to be analyzed. The vertical position of an instance of a node 1506 is determined by the distance between that node and the ontological leaves compared to the supplied leaves. This and other placement metrics can be calculated in a number of ways as the user determines and feeds into the functional flow. An example has the vertical distance calculated as a weighted sum of the number of links to information sources 21, 22 leaves weighted by the number of similarly information sources leaves within two steps subtracted from a similar weighted sum of the number of links to ontological leaves 17, 18.

The zone on the right 1505 displays “expected paths” that the leaf on the left may create, as projected by an introspective functional flow. The projected paths exist only in an introspective embodiment in which the system is reasoning about how it reasons. Such an embodiment is made possible by the appropriate ontologies and functional assembly rules.

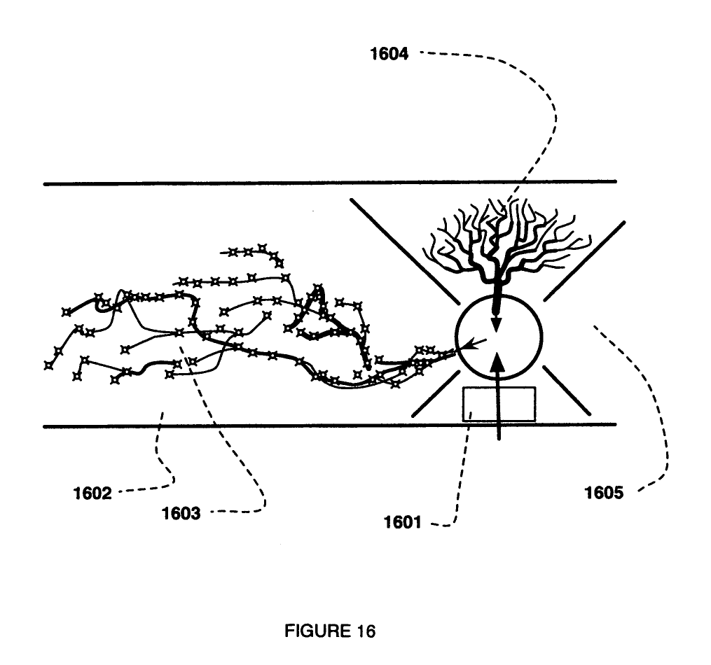

FIG. 16 illustrates a typical user view that exploits this “semantic distance” metric, providing more information. The historical trace 1601 of FIG. 14 is placed in the four-zone context of FIG. 15. This view adds information about the functional flow associated with the functional flow at the current time, and associated with a specific collection of information. In this case, the collection of information is that carried by a streaming video. The frame of the video which the view elucidates 1601 in the figure is at 26 minutes and 5 seconds from the beginning of the video.

The historical zone 1602 shows the history of frames prior to this moment, streaming from the center. Should a viewer want a similar view of a prior frame, there are two options. One option simply roles back the timeline to show the relationships as they were at that time. A second option is to select an instance of that frame 1603 in the interpretive history. In this case, the view will be different, showing additional insights gleaned from every bit of information, received and deduced, since that moment.

FIG. 16 shows the case where the system is analyzing the video and only has received it up to the moment displayed. Presumably, other streams are being received and analyses within the context of the larger functional flow. The collection of combined tree figures in the upper zone 1604 is analogous to the connections made between that collection of leaves 1601 and other relevant leaves via the functional flow. Should a user wish, she could follow those paths, auditing the flow, either from the current collection of leaves denoted by the center, or from any historical element. A tool for directly modifying the function flow is shown in a later figure.

FIG. 16 also shows a speculative set of connections with future states. If that future has not yet occurred, these are computed possibilities representing possible extensions of the history 1603. If the view is retrospective and some or all of the relevant future has occurred, then this zone shows the actual futures.

Each connection between nodes, no matter how close, is a functional link 820.

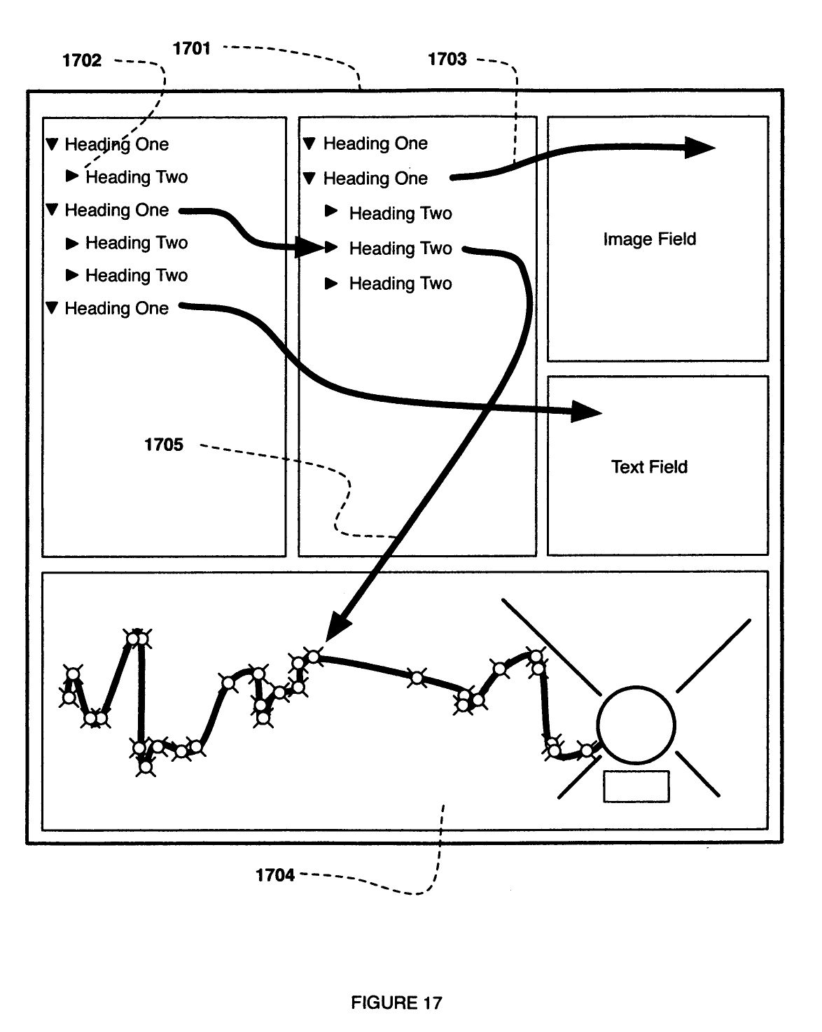

FIG. 17 integrates the two displays of functional links. The top part of the display shows the referenced invention. Functional links 820 are displayed in two ways: as parent-child relationship in the outline 1702, and as drawn lines among elements, some of which are displayed 1703. The types of these links are displayed by color and other visual characteristics. Each pane represents a different view, perspective, situation and/or ontology.

The bottom pane of the display 1704 has the simplified relational history of FIG. 15. The structures within that area are combinations of the same functional relationships shown among outlines as lines, but the information is more dense. These two displays can be tightly integrated by displaying or creating any new link 1705 between the bottom area and the top, just as the user would between outline or other information panes.

Thus, the user has several ways of viewing information in context and among several contexts, perhaps with different ontologies. The user also is capable of adding new leaves directly by making a new entry in the interface. The user also can make more fundamental changes in the system. She can create a new functional relationship by simply dragging and dropping between two elements and selecting a functional type from the options available 19, 20. If one of those options is not suitable, she can create a new function, shown in the display as a new link type. In either case, the functional array of FIG. 8 will adapt accordingly. But what if she wants to change a functional relationship that the system has already determined is proper? The challenge is to make the change based on the relative confidence of the user balanced against that of the system.

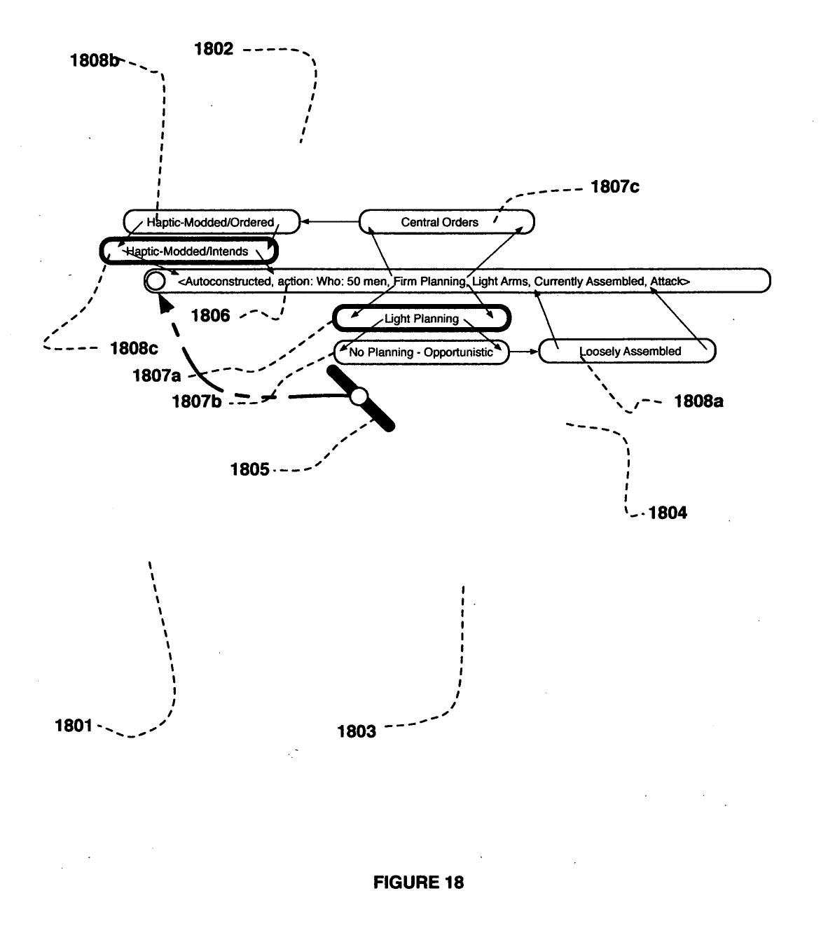

FIG. 18 shows a novel interface for user modification of established functional links. The example is shown in an application window 1801 with a toolbar, though this is not necessary. Some axioms for functional composition allow views in normal vector spaces such as Hilbert space. While this is not necessary, FIG. 18 shows such a decomposition with a two-dimensional grid 1803, denoting the two reference dimensions of the view. These can be user selected or machine determined to provide a useful geometry.

FIG. 18 shows fragments 1804 of four functional assemblies, the origin perhaps having been selected from a node 1705 in another display. Each of these represents a predicate statement, the shape indicating something of the nature of the predicate. In the figure, a user has selected to zoom in on one segment 1805 of one of the assemblies. In response, the system has overlain structured information 1806 representing the results of the functional flow at that point. In the figure, the example information reports that the conclusion is that the system has constructed the conclusion that a group of 50 men have been observed to be assembled for an attack. They are lightly armed and have a well developed plan of attack. The user believes that some detail is not correct based on information she has not linked to the sources in the example.

She moves to modify the fact of the construction 1805 associated with the statement 1806, believing that indeed the 50 men are assembled and armed but with no plan. The example is designed for a user interface that allows for haptic feedback, perhaps using a glove. She grabs the element 1805 and pulls it in the direction indicated by the Hilbert space grid 1803, with the intent of modifying “firm planning” to “light planning.”

As the element is moved, the options appear 1807, in line. FIG. 18 shows four options: “Central Orders,” “Firm Planning,” “Light Planning,” “No Planning but Opportunistic,” (meaning that they would attach if the opportunity arose). The operator wishes to correct the system by modifying the existing link. The system's confidence is indicated with the degree of resistance the operator feels in changing. If the resistance is great, then the functional flow has performed an audit and has supporting information not shown to the operator for some reason. If the resistance is not great, the information not shown is relatively insignificant. During this process, the functional flow performs an operation only supported with two-sorted logic. It made the original deduction from streaming reactive sources. It also made a deduction about how it made that that deduction, and how sound the process and facts were.

As the user moves the element with her glove, other dependent changes are indicated 1808. For example, if the operator chooses to complete the change from “Firm Planning” to “No Planning—Opportunistic,” then the deduction that the group is assembled will move to a less organized fact: “Loosely Assembled” 1808a. Once the new element in the functional flow is manually modified, The flow reactively adjusts.

While the above figures and descriptions substantially are made in regard to a server-client distributed computer system model, the system's functionality is not limited to such a model. This is because both servers and clients share the same ability to be reactive and perform incremental computing through functional programming and object-oriented programming. As both clients and servers comprise cells, the functionality is not unique to only clients, only servers, or the only by combination of the two. This ability to manage information can occur wholly on a lone client model, or a client-to-client (peer-to-peer) model of computing, without the need for a server. The above description and drawings illustrate embodiments which achieve the objects, features, and advantages described. Although certain advantages and embodiments have been described above, those skilled in the art will recognize that substitutions, additions, deletions, modifications and/or other changes may be made.

What is claimed as new and desired to be protected by Letters Patent of the United States is:

1. A distributed computer system for providing reactive transformation of information, the system comprising:
a server, having a
a server memory configured to store information from an information source;
a server processor configured to perform a function on the stored information to create transformed information; and
a communications device configured to transmit the transformed information;
a client, having a
a client communications device configured to receive the transformed information from the server;
a client memory configured to store received transformed information;
a client processor configured to perform a function on the transformed information to create further transformed information; and
a display configured to display a representation of the further transformed information;
wherein functions performed by the processors are performed using incremental computing and functional programming.

2. The system of claim 1, wherein the system further comprises a first signal to relate stored information with transformed information.

3. The system of claim 2, wherein the system further comprises a second signal to relate transformed information with further transformed information.

4. The system of claim 1, wherein the processors transform information by using mathematical functions and avoiding state data.

5. The system of claim 1, wherein the client accepts a query.

6. The system of claim 5, the system further comprising a user interface coupled to the client, wherein the user interface can accept the query.

7. The system of claim 5, wherein the processors transform information and further transform information in relation to the query.

8. The system of claim 6, wherein further transformed information is only processed if it is dependent on the query or the transformation of information.

9. The system of claim 1, wherein changes to stored information will force the processors to reperform functions on all transformed information and further transformed information dependent on the stored information.

10. The system of claim 1, further comprising a server-client boundary.

11. The system of claim 10, wherein the server-client boundary is determined based on the factors selected from the group consisting of bandwidth, latency, computing power, memory, and security.

12. A method to manage and display information flow, the method comprising:
using a server processor to perform functions on a stored information to create transformed information;
using a client processor to perform functions on the transformed information to create further transformed information;
using a first signal to represent the relationship between stored information and transformed information;
using a second signal to represent the relationship between transformed information and further transformed information;
using a client processor to create and display results in the context of methods;
wherein
the server and client processors use functional computing, the transformed information and further transformed information is incrementally computed.

13. The method of claim 12, further comprising:
receiving a query;
responding to the query comprising:
creating a third signal representing an expression based on the query;
determining if the expression has been responded to;
determining if the expression is a function application where the expression has not been responded to;
determining if the expression is a lambda expression where the expression is a function application,
performing a beta reduction where the expression is a lambda expression;
evaluating at least one input to the expression by performing the at least one function on the stored information to create the transform of information.

14. The method of claim 12, further comprising:
using the first signal to update transformed information when stored information changes; and
updating the first signal.

15. The method of claim 14, further comprising:
using the second signal to update further transformed information when transformed information changes; and
updating the second signal.

16. A distributed system for providing reactive transformation of information, the system comprising:
a server, comprising:
a memory configured to store information from a plurality of information sources;
a processor configured to transform stored information from at least one of the information sources by applying a first function; and
a communication device configured to transmit the transformed information;
a client, comprising:
a communications device configured to receive the transformed information;
a processor configured to further transform at least some of the transformed information by applying a second function; and
a display configured to display a representation of the further transformed information to a user,
wherein at least one of the first and second functions is applied based on a user query and the server processor is configured to automatically update the transformed information by again applying the first function when the information from the at least one information source changes.

17. The system of claim 16, wherein the server memory is further configured to store a dependency record of the information upon which the transformed information depends.

18. The system of claim 17, wherein the server processor is further configured to automatically update the transformed information by again applying the first function only when the dependency record indicates information upon which the transformed information depends has changed.

19. The system of claim 16, wherein the first function comprises a computation tree constructed from a plurality of template functions based on the user query.

20. The system of claim 19, wherein the computation tree is partially constructed by the client processor.

21. The system of claim 16, wherein the server and the client are the same physical computer.

22. The system of claim 12, wherein the display contains information about functional relationships from information the first signal and ontological references.

23. The system of claim 16, wherein the display of the computation tree provides affordances to allow modification of ontological context.

24. The system of claim 16, wherein the display of the computation tree provides affordances to allow modification of the functional array.
